(19) United States
(12) Patent Application Publication
(10) Pub. No.: US 2012/0133461 A1
(43) Pub. Date: May 31, 2012

(54) RIVERSIBLE ELECTROMAGNETIC CONTACTOR

(75) Inventors: Yasuhiro Naka, Kounosu-shi (JP); Toshikatsu Ohgami, Kounosu-shi (JP); Koji Okubo, Kumagaya-shi (JP); Kouetsu Takaya, Kounosu-shi (JP); Kenji Suzuki, Kounosu-shi (JP)

(73) Assignee: FUJI ELECTRIC FA COMPONENTS & SYSTEMS CO., LTD., Chuo-ku, Tokyo (JP)

(21) Appl. No.: 13/322,035

(22) PCT Filed: Jun. 14, 2010
(86) PCT No.: PCT/JP2010/003938

§ 371 Date: Jan. 10, 2012

(30) Foreign Application Priority Data
Aug. 20, 2009 (JP) 2009-190589

(51) Int. Cl. H01H 3/54

(52) U.S. Cl. 335/157

(57) ABSTRACT

An electromagnetic contactor (1a) is provided with an erroneous mounting prevention unit (8) which permits an entry of a connection piece when a connection piece (6f) of a reversible unit (6) attempts to enter a normal position (NP) inside a display window (3a) where the connection piece is connectable to an operation display piece (4a), and prevents the entry of the connection piece when the connection piece attempts to enter a position inside the display window (3a) deviated from the normal position (NP).

### TECHNICAL FIELD

The present invention relates to a reversible electromagnetic contactor in which a reversible unit is mounted over two electromagnetic contactors disposed adjacent to each other.

### BACKGROUND ART

As a reversible electromagnetic contactor that is connected to a power feeding circuit of an induction motor and performs a normal and reverse operation control of the induction motor, there is known a device in which a reversible unit is mounted so as to extend over two electromagnetic contactors disposed adjacent to each other and mechanically locks the operation in which two electromagnetic contactors simultaneously enter a closed-circuit (ON) state (for example, Patent Document 1).

FIGS. 11 to 14 specifically illustrate a conventional reversible electromagnetic contactor.

As shown in FIG. 11, two electromagnetic contactors 1a and 1b disposed adjacent to each other have a structure in which display windows 3a and 3b are respectively provided in arc-extinguishing covers 2a and 2b and operation display pieces 4a and 4b are respectively provided inside the display windows 3a and 3b to protrude from the inside of the device.

As shown in FIG. 12, the operation display piece 4a of one electromagnetic contactor 1a is a member which is fixed to a movable contact support 4 disposed inside the electromagnetic contactor 1a and extends toward the inside of the display window 3a. Then, the operation display piece may check an operation of the movable contact support 4 since the position of the operation display piece 4a changes inside the display window 3a as well as a closed-circuit (ON) operation and an opened-circuit (OFF) operation of the movable contact support 4. Further, since the position of the operation display piece 4b of the other electromagnetic contactor 1b also changes inside the display window 3b, a closed-circuit (ON) operation and an opened-circuit (OFF) operation of a movable contact support (not shown) disposed inside the electromagnetic contactor 1b may be checked.

As shown in FIG. 11, a reversible unit 6 includes a unit bottom plate 6a which is connected to the arc-extinguishing covers 2a and 2b in such a state as to extend over two electromagnetic contactors 1a and 1b and a unit cover 6b, a peripheral edge portion of which engages a peripheral edge of the unit bottom plate 6a, where in the internal space of the unit bottom plate 6a and the unit cover 6b, first and second rotation plates 6c and 6d are rotatably connected to a rotation regulation member 6e. Further, cylindrical connection pieces 6f and 6g are respectively formed at the end portions of the first rotation plate 6c and the second rotation plate 6d to protrude outward through open portions 6h and 6i formed in the bottom plate 6a. Then, a plurality of hook portions 6j is formed at the unit bottom plate 6a, and a plurality of engagement holes 2c is formed in the arc-extinguishing covers 2a and 2b to correspond to the hook portions 6j. When the unit bottom plate 6a contacts the arc-extinguishing covers 2a and 2b, the plurality of hook portions 6j detachably engages with the corresponding engagement holes 2c.

Then, when the connection pieces 6f and 6g of the reversible unit 6 are fitted to the head portions of the operation display pieces 4a and 4b of two electromagnetic contactors 1a and 1b as shown in FIG. 13, the rotation regulation member 6e rotates one of the first rotation plate 6c and the second rotation plate 6d, restricts the rotation of the other thereof, permits the movement of only one of the operation display pieces 4a and 4b, and thus mechanically locks the operation in which two electromagnetic contactors 1a and 1b simultaneously enter a closed-circuit (ON) state.

### CITATION LIST

### Patent Document

Patent Document 1: Japanese Patent Application Laid-Open No. 03-266325

### DISCLOSURE OF THE INVENTION

### Problems to be Solved by the Invention

However, the reversible unit 6 does not include a holding member such as a spring member that holds the initial positions of the connection pieces 6f and 6g in order to reduce a load applied thereto when the reversible unit is connected to the electromagnetic contactors 1a and 1b. For this reason, when mounting the reversible unit 6 so as to extend over two electromagnetic contactors 1a and 1b, as shown in FIG. 14, if the connection piece 6f protruding from the open portion 6h and the initial position of which is not set is deviated from a normal position where the connection piece is connectable to the operation display piece 4a, there is a concern that the reversible unit 6 is mounted onto the electromagnetic contactors 1a and 1b while the connection piece 6f is not connected to the operation display piece 4a. Furthermore, although not shown in the drawings, when mounting the reversible unit 6, the other connection piece 6g may not be connected to the operation display piece 4b in some cases.

Therefore, the invention is made in view of the problems to be solved in the above-mentioned conventional example, and an object thereof is to provide a reversible electromagnetic contactor capable of preventing an erroneous mounting of a reversible unit by preventing the mounting of the reversible unit onto two electromagnetic contactors when a connection piece is not properly connected to an operation display piece.

### Means for Solving the Problems

In order to attain the above-described object, a reversible electromagnetic contactor according to an embodiment includes a pair of electromagnetic contactors disposed adjacent to each other and a reversible unit mounted over the electromagnetic contactors. The pair of electromagnetic contactors includes a movable contact support accommodated inside a body casing and an operation display piece fixed to the movable contact support and protruding toward a display window provided in a unit mounting portion of the body casing. The reversible unit allows a pair of connection pieces, initial positions of which are not held, to enter the display window so that they are respectively connected to the operation display pieces. An erroneous mounting prevention unit is provided in at least one of the electromagnetic contactors or the connection pieces to permit an entry of the connection piece when the connection piece attempts to enter a normal position inside the display window where the connection piece is connectable to the operation display piece, and to prevent the entry of the connection piece when the connection piece attempts to enter a position inside the display window deviated from the normal position.

In the reversible electromagnetic contactor according to the embodiment, the mounting of the reversible unit to the pair of electromagnetic contactors is prevented when the connection piece is not properly connected to the operation display piece, thereby preventing the erroneous mounting of the reversible unit.

Further, in the reversible electromagnetic contactor according to an embodiment, the erroneous mounting prevention unit is an entry regulation unit which is provided in a portion of the movable contact support facing the display window. The entry regulation unit does not contact the connection piece when the connection piece attempts to enter the normal position inside the display window, and contacts the connection piece to prevent the entry thereof when the connection piece attempts to enter a position deviated from the normal position.

In the reversible electromagnetic contactor according to the embodiment, the entry regulation portion formed in the movable contact support prevents the movement of the reversible unit having the connection piece of which the initial position is not held when the connection piece attempts to enter the display window from a position other than the normal position, thereby reliably preventing a state where the connection piece is not properly connected to the operation display piece.

Further, in the reversible electromagnetic contactor according to an embodiment, the erroneous mounting prevention unit includes a concave portion which is provided in the movable contact support around the operation display piece and a convex portion which is provided in a front end of the connection piece. When the connection piece attempts to enter the normal position inside the display window, the convex portion enters the concave portion to permit the mounting of the reversible unit onto the unit mounting portion. When the connection piece attempts to enter a position deviated from the normal position, the convex portion contacts the movable contact support other than the concave portion to prevent the mounting of the reversible unit onto the unit mounting portion.

In the reversible electromagnetic contactor according to the embodiment, the concave portion provided in the movable contact support and the convex portion provided in the front end of the connection piece prevent the movement of the reversible unit having the connection piece of which the initial position is not held when the connection pieces attempts to enter the display window from a position other than the normal position, thereby reliably preventing a state where the connection piece is not properly connected to the operation display piece.

Further, in the reversible electromagnetic contactor according to an embodiment, the erroneous mounting prevention unit includes a first engagement entry regulation portion which is provided in a part of an inner wall forming the display window and a second engagement entry regulation portion which is provided in a front end of the connection piece to protrude outward. When the connection piece attempts to enter the normal position inside the display window, the first and second engagement entry regulation portions do not engage with each other to permit the mounting of the reversible unit onto the unit mounting portion. When the connection piece attempts to enter a position deviated from the normal position, the first and second engagement entry regulation portions engage with each other to prevent the mounting of the reversible unit onto the unit mounting portion.

In the reversible electromagnetic contactor according to the embodiment, the first engagement entry regulation portion provided in a part of the inner wall provided with the display window and the second engagement entry regulation portion provided in the front end of the connection piece to protrude outward prevent the movement of the reversible unit having the connection piece of which the initial position is not held when the connection piece attempts to enter the display window from a position other than the normal position, thereby reliably preventing a state where the connection piece is not properly connected to the operation display piece.

### EFFECTS OF THE INVENTION

According to the reversible electromagnetic contactor of the invention, the mounting of the reversible unit onto the pair of electromagnetic contactors may not be permitted when the connection piece is not properly connected to the operation display piece, and the erroneous mounting of the reversible unit may be reliably prevented.

### BRIEF DESCRIPTION OF THE DRAWINGS

FIG. 1 is a perspective view illustrating a main part of a reversible electromagnetic contactor of a first embodiment of the invention.

FIG. 2 is a diagram illustrating a state where a connection piece of a reversible unit of the first embodiment is not held at a normal position.

FIG. 3 is a diagram illustrating a state where the connection piece of the reversible unit of the first embodiment is held at the normal position and is connected to an operation display piece.

FIG. 4 is a diagram illustrating a state where a connection piece of a reversible unit of a second embodiment of the invention is not held at a normal position.

FIG. 5 is a diagram illustrating a state where the connection piece of the reversible unit of the second embodiment is held at the normal position and is connected to an operation display piece.

FIG. 6 is a diagram illustrating a shape of the connection piece of the second embodiment.

FIG. 7 is a perspective view illustrating a main part of a reversible electromagnetic contactor of a third embodiment of the invention.

FIG. 8 is a diagram illustrating a state where a connection piece of a reversible unit of the third embodiment is not held at a normal position.

FIG. 9 is a diagram illustrating a state where the connection piece of the reversible unit of the third embodiment is held at the normal position and is connected to an operation display piece.

FIG. 10 is a diagram illustrating an internal structure of the reversible electromagnetic contactor of the third embodiment when seen from a direction in which a movable contact support is driven.

FIG. 11 is an exploded perspective view illustrating a conventional reversible electromagnetic contactor.

FIG. 12 is a cross-sectional view of the conventional reversible electromagnetic contactor shown from a side portion.

FIG. 13 is a diagram illustrating a state where a connection piece of a reversible unit of the conventional reversible electromagnetic contactor is held at a normal position and is connected to an operation display piece.

FIG. 14 is a diagram illustrating a state where the connection piece of the reversible unit of the conventional reversible electromagnetic contactor is not held at the normal position.

### BEST MODE FOR CARRYING OUT THE INVENTION

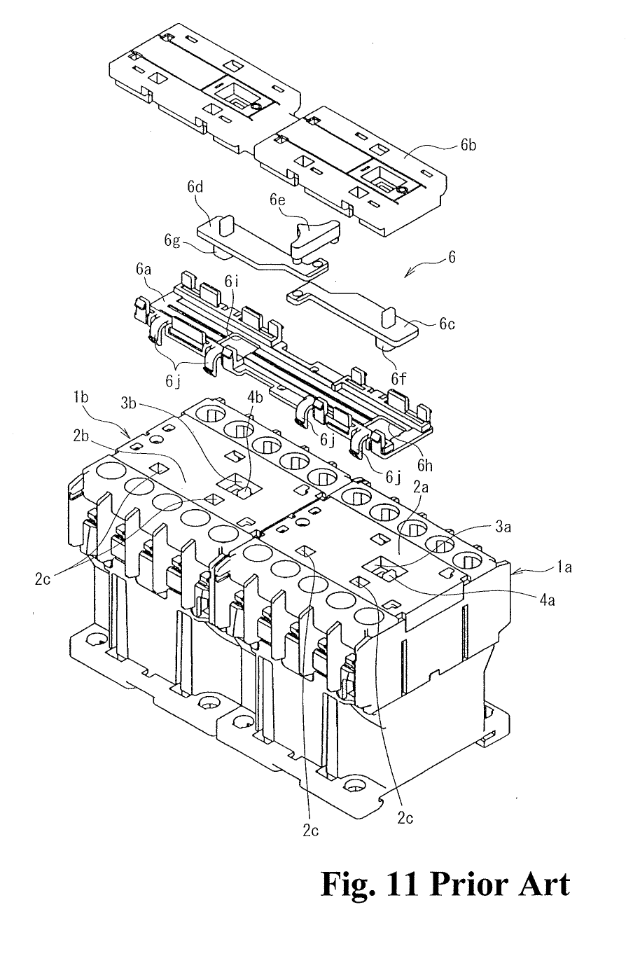

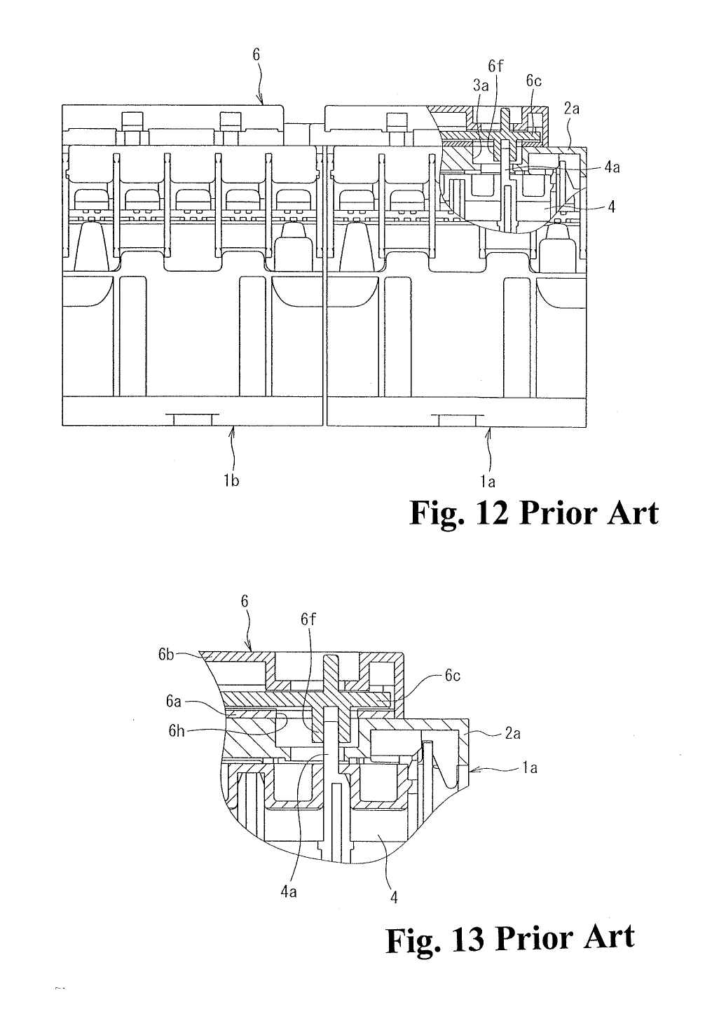

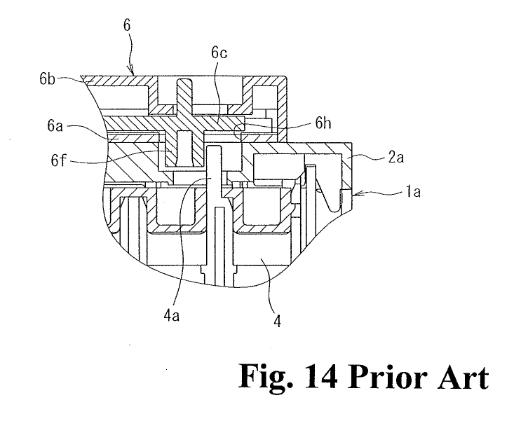

Hereinafter, a best mode for carrying out the invention (hereinafter, referred to as an embodiment) for a reversible electromagnetic contactor according to the invention will be described in detail by referring to the drawings. Furthermore, the same reference numerals will be given to the same components as those of FIGS. 11 to 14, and the description thereof will not be repeated.

In the respective embodiments to be described below, as in FIG. 11, two electromagnetic contactors 1a and 1b are disposed adjacent to each other, and a reversible unit 6 is mounted over the electromagnetic contactors 1a and 1b. However, only the mounted portion of one electromagnetic contactor 1a and the reversible unit 6 is shown.

### First Embodiment

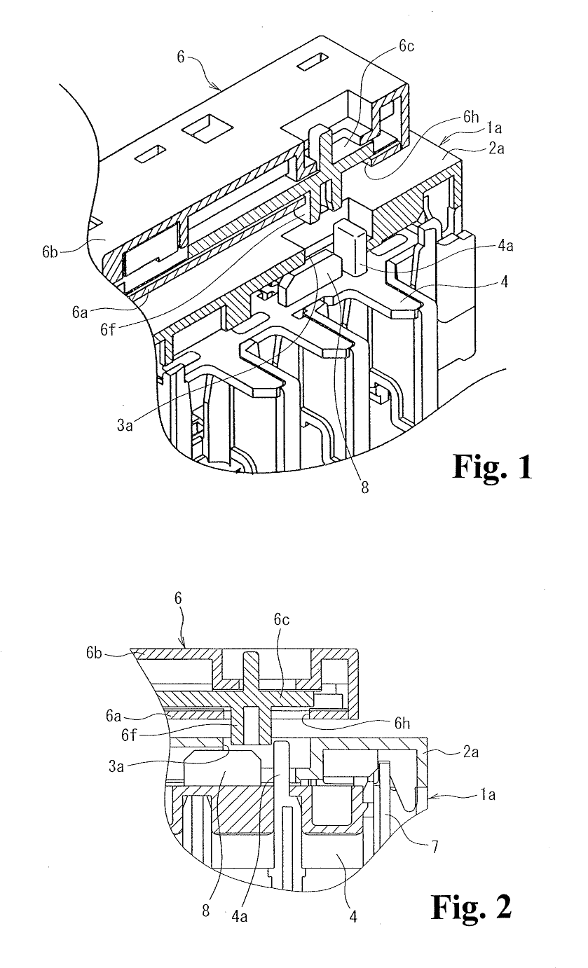

FIGS. 1 to 3 illustrate a reversible electromagnetic contactor of a first embodiment. A movable contact support 4 of one electromagnetic contactor 1a includes a plurality of movable contacts (not shown), and faces a plurality of fixed contacts disposed inside the electromagnetic contactor 1a. Further, an electromagnet is accommodated inside the electromagnetic contactor 1a to be parallel to the movable contact support 4, and a movable core of the electromagnet and the movable contact support 4 are connected to each other via a drive lever 7. Then, when an excitation coil of the electromagnet is excited, the movable core is driven, and the drive of the movable core is transmitted to the movable contact support 4 via the drive lever 7, whereby the open and close operation of the plurality of movable and fixed contacts corresponding to each other is performed.

Here, as shown in FIG. 1, the movable contact support 4 of the embodiment has a structure in which an entry regulation portion 8 is formed at a position adjacent to the operation display piece 4a to protrude toward a display window 3a.

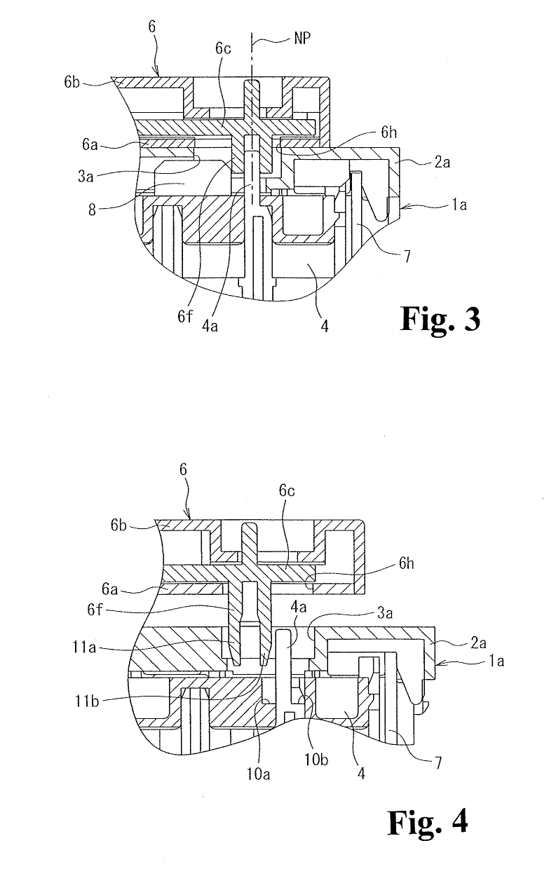

The entry regulation portion 8 permits the entry of a connection piece 6f toward the display window 3a when the connection piece 6f of the reversible unit 6 is located at a normal position NP where it may be fitted to the operation display piece 4a as shown in FIG. 3. The entry regulation portion 8 prevents the entry of the connection piece 6f toward the display window 3a by contacting the front end of the connection piece when the connection piece 6f attempts to enter the display window 3a from a position deviated from the normal position NP as shown in FIG. 2.

Further, an entry regulation portion 8 is also formed at a position adjacent to an operation piece 4b of the movable contact support 4 of the other electromagnetic contactor 1b to protrude toward a display window 3b. The entry regulation portion 8 permits the entry of a connection piece 6g toward the display window 3b when the connection piece 6g of the reversible unit 6 is located at the normal position NP where it may be fitted to the operation display piece 4b. The entry regulation portion 8 prevents the entry of the connection piece 6g toward the display window 3b by contacting the front end of the connection piece when the connection piece 6g attempts to enter the display window 3b from a position deviated from the normal position NP.

Furthermore, a unit mounting portion of the invention corresponds to arc-extinguishing covers 2a and 2b.

According to the above-described configuration, when any one of the connection pieces 6f and 6g protruding from open portions 6h and 6i of the reversible unit 6 is not located at the normal position NP where the connection pieces are connectable to the operation display pieces 4a and 4b of the movable contact support 4, the entry regulation portion 8 provided at a position adjacent to the operation display pieces 4a and 4b prevents the entry of the connection pieces 6f and 6g toward the display windows 3a and 3b as shown in FIG. 2, so that the reversible unit 6 may not be mounted onto the electromagnetic contactor 1a. On the other hand, in the reversible unit 6 allowing the connection pieces 6f and 6g to be located at the normal position NP as shown in FIG. 3, the connection pieces 6f and 6g enter the display windows 3a and 3b without being prevented by the entry regulation portion 8 to be fitted to the operation display pieces 4a and 4b, and a unit bottom plate 6a contacts the arc-extinguishing covers 2a and 2b so that a hook portion 6j and an engagement hole 2c engage with each other, whereby the reversible unit may be mounted onto the electromagnetic contactor 1a.

Accordingly, in the embodiment, the entry regulation portion 8 formed in the movable contact support 4 prevents the reversible unit 6 having the connection pieces 6f and 6g of which the initial positions are not held when the connection pieces 6f and 6g attempt to enter the display windows 3a and 3b from a position other than the normal position NP, thereby reliably preventing a state where the connection pieces 6f and 6g are not normally connected to the operation display pieces 4a and 4b.

Further, in the embodiment, since the mounting of the reversible unit 6 to two electromagnetic contactors 1a and 1b is not permitted while the connection pieces 6f and 6g of the reversible unit 6 are not normally connected to the operation display pieces 4a and 4b, a reversible electromagnetic contactor preventing an erroneous mounting of the reversible unit 6 may be provided.

Then, since the erroneous mounting of the reversible unit 6 is prevented, the safety of the reversible electromagnetic contactor performing a normal and reverse operation control of an induction motor may be reliably improved.

### Second Embodiment

Next, FIGS. 4 to 6 illustrate a reversible electromagnetic contactor of a second embodiment.

In the embodiment, as shown in FIG. 4, concave portions 10a and 10b are formed at two positions of a surface facing the display window 3a in the movable contact support 4. The concave portions 10a and 10b are formed around the operation display piece 4a.

Further, a pair of convex portions 11a and 11b is formed at the lower end of the connection piece 6f of the reversible unit 6, and the pair of convex portions 11a and 11b is formed to extend in parallel to each other as shown in FIG. 6.

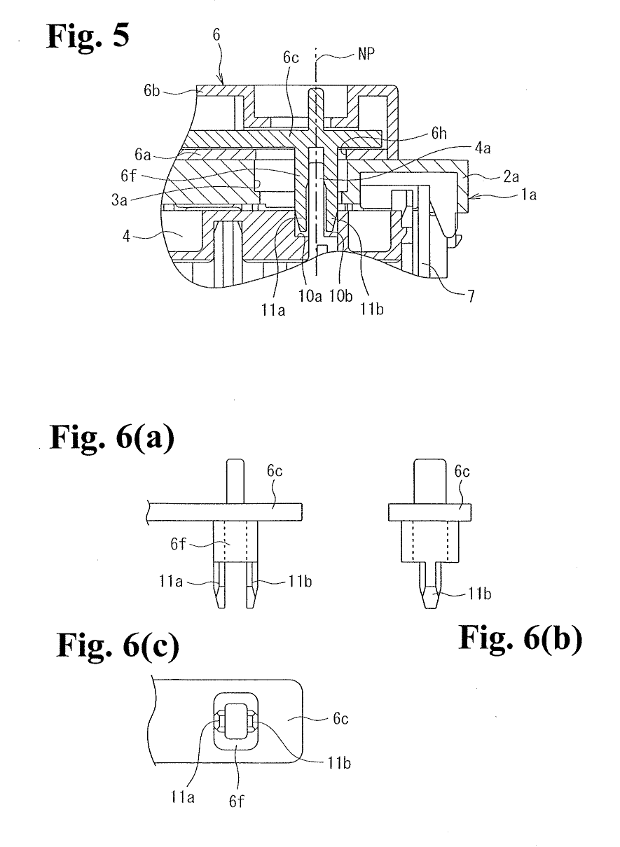

In the embodiment, when the connection piece 6f of the reversible unit 6 is located at the normal position NP where it may be fitted to the operation display piece 4a as shown in FIG. 5, the unit bottom plate 6a contacts the arc-extinguishing covers 2a and 2b, and the hook portion 6j and the engagement hole 2c engage with each other while the front ends of the pair of convex portions 11a and 11b formed at the lower end of the connection piece 6f are inserted into the concave portions 10a and 10b formed around the operation display piece 4a, whereby the reversible unit may be mounted onto the electromagnetic contactor 1a.

On the other hand, when the connection piece 6f attempts to enter the display window 3a from a position deviated from the normal position NP as shown in FIG. 4, the convex portions 11a and 11b of the connection piece 6f contact a surface without the concave portions 10a and 10b in the movable contact support 4, and the unit bottom plate 6a is spaced from the arc-extinguishing covers 2a and 2b, whereby the reversible unit 6 may not be mounted onto the electromagnetic contactor 1a.

Further, although not shown in the drawings, concave portions 10a and 10b having the same structure are also formed at two positions of a surface facing the display window 3a in the movable contact support 4 of the other electromagnetic contactor 1b, and a pair of convex portions 11a and 11b having the same structure is also formed at the lower end of the connection piece 6g of the reversible unit 6, thereby obtaining the same effect.

Accordingly, even in the embodiment, the concave portions 10a and 10b formed at two positions of the movable contact supports 4 of the electromagnetic contactors 1a and 1b and the pair of convex portions 11a and 11b formed at the lower ends of the connection pieces 6f and 6g of the reversible unit 6 prevents the movement of the reversible unit 6 having the connection pieces 6f and 6g of which the initial positions are not held when the connection pieces 6f and 6g attempt to enter the display windows 3a and 3b from a position other than the normal position NP, thereby reliably preventing a state where the connection pieces 6f and 6g are not normally connected to the operation display pieces 4a and 4b.

Further, in the embodiment, since the mounting of the reversible unit 6 to two electromagnetic contactors 1a and 1b is not permitted while the connection pieces 6f and 6g of the reversible unit 6 are not normally connected to the operation display pieces 4a and 4b, a reversible electromagnetic contactor preventing an erroneous mounting of the reversible unit 6 and improving the safety may be provided.

### Third Embodiment

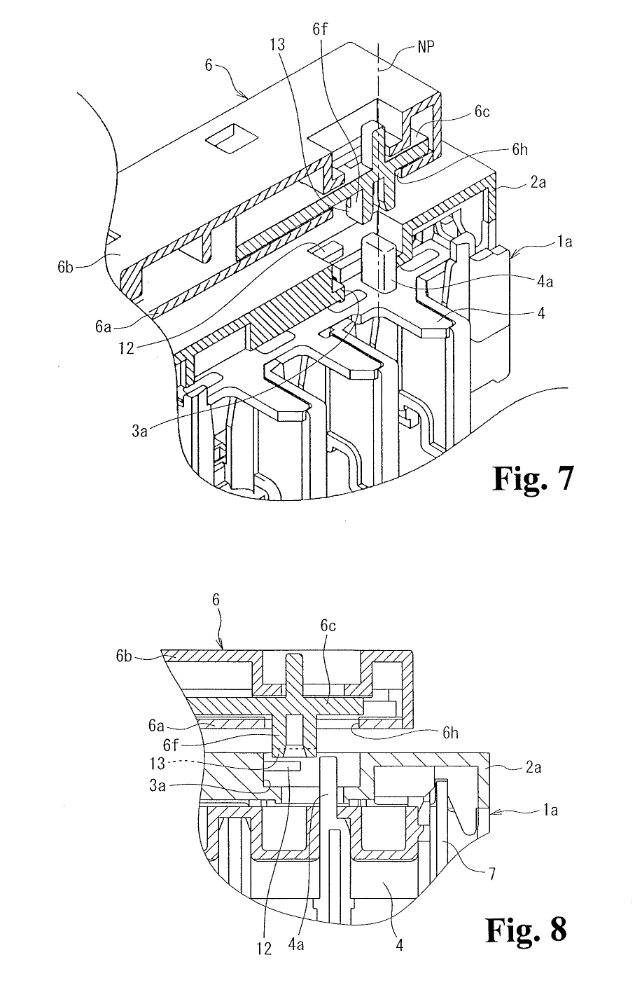

Further, FIGS. 7 to 10 illustrate a reversible electromagnetic contactor of a third embodiment.

In the embodiment, as shown in FIG. 7, a first engagement entry regulation portion 12 is formed in a protruding manner in an inner wall provided with the display window 3a in the electromagnetic contactor 1a. The first engagement entry regulation portion 12 is formed only at an inner wall of the display window 3a deviated from the normal position NP where the connection piece 6f of the reversible unit 6 may be fitted to the operation display piece 4a.

As shown in FIG. 10(a), a second engagement entry regulation portion 13 is formed at the lower portion of the connection piece 6f of the reversible unit 6 to protrude outward, and the second engagement entry regulation portion 13 prevents the entry of the connection piece 6f while engaging with the first engagement entry regulation portion 12 when the connection piece 6f attempts to enter from a position deviated from the normal position NP of the display window 3a.

Further, although not shown in the drawings, a first engagement entry regulation portion 12 is also formed in a protruding manner in an inner wall deviated from the normal position NP of the display window 3b of the other electromagnetic contactor 1b. Then, a second engagement entry regulation portion 13 is also formed in the lower portion of the connection piece 6g of the reversible unit 6 to protrude outward, and prevents the entry of the connection piece 6g while engaging with the first engagement entry regulation portion 12 formed in the display window 3b when the connection piece 6g attempts to enter from a position deviated from the normal position NP of the display window 3b.

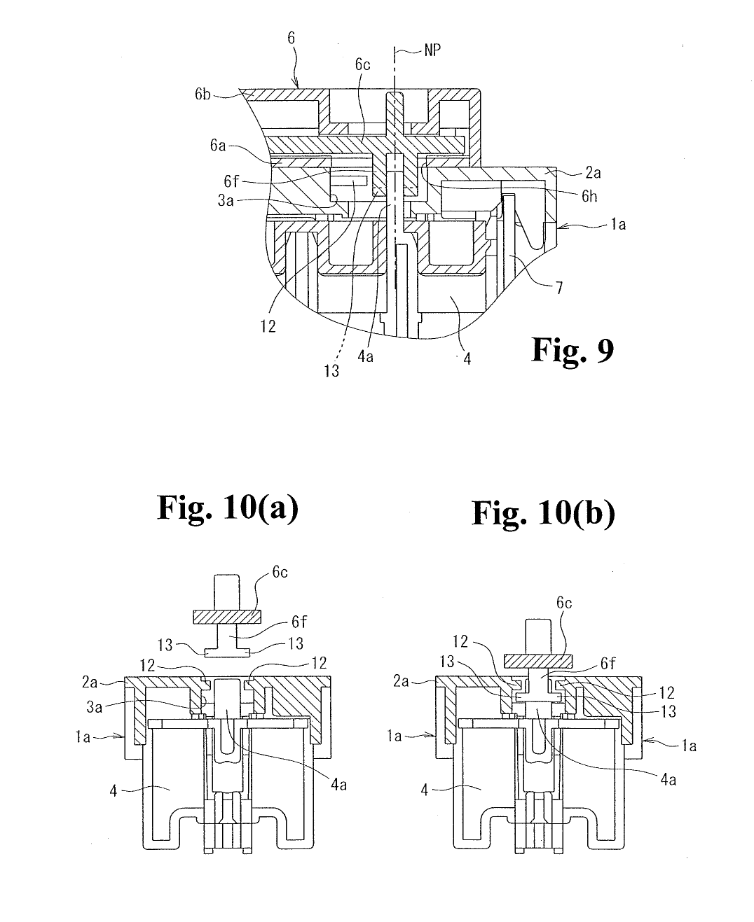

According to the above-described configuration, when any one of the connection pieces 6f and 6g protruding from the open portions 6h and 6i of the reversible unit 6 is located at a position deviated from the normal position NP where the connection pieces are connectable to the operation display pieces 4a and 4b of the movable contact support 4 as shown in FIG. 8, the first engagement entry regulation portions 12 protruding from the inner walls of the display windows 3a and 3b and the second engagement entry regulation portion 13 protruding from the lower portions of the connection pieces 6f and 6g engage with each other to prevent the entry of the connection pieces 6f and 6g, whereby the reversible unit 6 may not be mounted onto the electromagnetic contactors 1a and 1b. On the other hand, in the reversible unit 6 allowing the connection pieces 6f and 6g to be located at the normal position NP as shown in FIG. 9, the second engagement entry regulation portions 13 of the connection pieces 6f and 6g do not contact the first engagement entry regulation portions 12 of the display windows 3a and 3b, the connection pieces 6f and 6g enter the display windows 3a and 3b to be fitted to the operation display pieces 4a and 4b, and the unit bottom plate 6a contacts the arc-extinguishing covers 2a and 2b so that the hook portion 6j and the engagement hole 2c engage with each other, whereby the reversible unit may be mounted onto the electromagnetic contactors 1a and 1b. Then, when the connection pieces 6f and 6g are connected to the operation display pieces 4a and 4b, the second engagement entry regulation portion 13 located at the lower portion of the first engagement entry regulation portion 12 does not have any influence in a direction in which the movable contact support 4 is driven as shown in FIG. 10(b).

Accordingly, even in the embodiment, the first engagement entry regulation portions 12 formed in the inner walls provided with the display windows 3a and 3b and the second engagement entry regulation portions 13 protruding from the lower portions of the connection pieces 6f and 6g prevent the movement of the reversible unit 6 having the connection pieces 6f and 6g of which the initial positions are not held when the connection pieces 6f and 6g attempt to enter the display windows 3a and 3b from a position other than the normal position NP, thereby reliably preventing a state where the connection pieces 6f and 6g are not normally connected to the operation display pieces 4a and 4b.

Further, in the embodiment, since the mounting of the reversible unit 6 to two electromagnetic contactors 1a and 1b is not permitted while the connection pieces 6f and 6g of the reversible unit 6 are not normally connected to the operation display pieces 4a and 4b, the reversible electromagnetic contactor preventing an erroneous mounting of the reversible unit 6 and improving the safety may be provided.

### INDUSTRIAL APPLICABILITY

As described above, the reversible electromagnetic contactor according to the invention may prevent the mounting of the reversible unit onto two electromagnetic contacts in a state where the connection piece is not properly connected to the operation display piece, and effectively prevent the erroneous mounting of the reversible unit.

### EXPLANATION OF LETTERS AND NUMERALS

1a, 1b: electromagnetic contactor

2a, 2b: arc-extinguishing cover

2c: engagement hole

3a, 3b: display window

4: movable contact support

4a, 4b: operation display piece

6: reversible unit

6a: unit bottom plate

6b: unit cover

6c: first rotation plate

6d: second rotation plate

6e: rotation regulation member

6f, 6g: connection piece

6h, 6i: open portion

6j: hook portion

7: drive lever

8: entry regulation portion

10a, 10b: concave portion

11a, 11b: convex portion

12: first engagement entry regulation portion

13: second engagement entry regulation portion

What is claimed is:

1. A reversible electromagnetic contactor comprising:
a pair of electromagnetic contactors disposed adjacent to each other; and
a reversible unit mounted over the electromagnetic contactors;
wherein the pair of electromagnetic contactors includes a movable contact support accommodated inside a body casing, and an operation display piece fixed to the movable contact support and protruding toward a display window provided in a unit mounting portion of the body casing;
the reversible unit enters a pair of connection pieces not held in the initial position to an inside of display window to respectively connect to the operation display pieces; and
at least one of the electromagnetic contactors and the connection pieces includes an erroneous mounting prevention unit to permit an entry of the connection piece when the connection piece attempts to enter a normal position inside the display window connectable to the operation display piece, and to prevent the entry of the connection piece when the connection piece attempts to enter a position inside the display window deviated from the normal position.

2. A reversible electromagnetic contactor according to claim 1, wherein the erroneous mounting prevention unit is an entry regulation unit provided on a portion of the movable contact support facing the display window; and
the entry regulation unit does not contact the connection piece when the connection piece attempts to enter the normal position inside the display window, and contacts the connection piece to prevent the entry thereof when the connection piece attempts to enter a position deviated from the normal position.

3. A reversible electromagnetic contactor according to claim 1, wherein the erroneous mounting prevention unit includes a concave portion provided in the movable contact support around the operation display piece and a convex portion provided at a front end of the connection piece;
when the connection piece attempts to enter the normal position inside the display window, the convex portion enters the concave portion to permit the mounting of the reversible unit onto the unit mounting portion; and
when the connection piece attempts to enter a position deviated from the normal position, the convex portion contacts the movable contact support other than the concave portion to prevent the mounting of the reversible unit onto the unit mounting portion.

4. A reversible electromagnetic contactor according to claim 1, wherein the erroneous mounting prevention unit includes a first engagement entry regulation portion provided in a part of an inner wall forming the display window and a second engagement entry regulation portion provided at a front end of the connection piece to protrude outward;
when the connection piece attempts to enter the normal position inside the display window, the first and second engagement entry regulation portions do not engage with each other to permit the mounting of the reversible unit onto the unit mounting portion; and
when the connection piece attempts to enter a position deviated from the normal position, the first and second engagement entry regulation portions engage with each other to prevent the mounting of the reversible unit onto the unit mounting portion.
